(19) United States
(12) Patent Application Publication
(10) Pub. No.: US 2007/0089928 A1
(43) Pub. Date: Apr. 26, 2007

(54) Climbing Device with Removable Step

(76) Inventor: Lonnie Dean Evans, Rosemount, MN (US)

Correspondence Address: MAEYAERT & MAEYAERT, 2091 COUNTY ROAD D EAST, SUITE C-100, MAPLEWOOD, MN, 55109, US

(21) Appl. No.: 11/163,611

(22) Filed: Oct. 25, 2005

(51) Int. Cl. E06C 9/00

(52) U.S. Cl. 182/92

(57) ABSTRACT

A portable step including a strap assembly, a step assembly and a locking system. The strap assembly includes a strap and a buckle that can be locked in place using a locking system. The step assembly includes a base portion and a step portion. The strap assembly and base portion may be secured to a tree. The step portion is removable allowing the base portion and strap assembly to be left secured to a tree so that others may not take or use the portable step, yet allowing the user to return to easily reattach the step portion to the base portion of the step assembly allowing reuse of the portable step.

### FIELD OF INVENTION

The present invention relates to the field of portable climbing devices. More particularly, this invention relates to a portable step that provides a removable step and a locking system. The present invention overcomes problems with tree climbing devices that damage trees or that can be easily used by or taken by others.

### BACKGROUND OF INVENTION

The desire to climb objects, trees in particular, to gain a higher viewpoint has been an object of many. Hunters, in particular, prefer the advantage of an elevated position to view and capture their prey. Many trees and poles lack usefully placed steps or stepping platforms to facilitate easy climbing.

Many devices have been used to make tree climbing easier. Many devices cause damage to trees, such as screws and spikes. Most require significant time to install and properly position. During a hunting season, hunters typically like to use the same tree a number of times over several weeks. A hunter will usually setup any equipment needed for the desired hunt a day or more prior to hunting season, and leave the equipment in place for a few days or weeks. This may include putting a tree stand in place and providing climbing steps to get up to the tree stand. However, leaving the climbing device in place invites theft of the device or use by someone else. Therefore, the hunter is forced to remove and re-install the climbing device each time the climber re-visits the same tree.

### SUMMARY OF INVENTION

One aspect of the invention includes a portable step having a strap assembly and a step assembly. The strap assembly is removably attachable to a climbable object. The strap assembly is long enough to circumscribe the object and is attachable to the object by circumscribing the object. The step assembly has a base portion and a step portion. The base portion is attached to the strap assembly and the step portion is removably attachable to the base portion. The step assembly has a climbing position and a non-climbing position. The climbing position includes an attached step portion and provides a step. The non-climbing position detaches the step portion.

Another aspect of the invention includes a base portion having a beveled top.

Another aspect of the invention includes a base portion having a stem for inserting into a channel with the stem and the channel having at least two mating surfaces.

Another aspect of the invention includes a step assembly having at least one locking lip and at least one locking edge.

Another aspect of the invention includes a strap assembly having a buckle including a buckle base and a hook with the buckle base having a cam, and the cam securing one end of a strap of the strap assembly.

Another aspect of the invention includes a locking system.

Another aspect of the invention includes a locking system having a plurality of holes in a strap of the strap assembly and an opening in a buckle of the strap assembly.

Another aspect of the invention includes a strap assembly having a strap and a buckle.

One aspect of the invention includes a portable step having a strap assembly, a step assembly, and a locking mechanism. The strap assembly is removably attachable to a climbable object. The strap assembly is long enough to circumscribe the object and is attachable to the object by circumscribing the object. The step assembly has a climbing position and a non-climbing position. The climbing position provides a step. The locking system is attached to the strap assembly so that the strap assembly is securable to the climbable object. The strap assembly is lockably securable to the object while the step assembly is in either the climbing position or non-climbing position.

Another aspect of the invention includes a locking system having a plurality of openings in a strap of the strap assembly and an opening in a hook of a buckle of the strap assembly.

Another aspect of the invention provides that the step assembly has a base portion and a step portion with the base portion attached to the strap assembly. The step portion is removably attachable to the base portion. The climbing position includes an attached step portion and provides a step. The non-climbing position includes a detached step portion.

One aspect of the invention includes a portable step having an object securing means, a locking means, and an incapacitating means. The object securing means is for attaching the portable step to an object so that the object can be climbed. The locking means is for securing at least a portion of the portable step to the object to prevent other users from removing the portable step from the object. The incapacitating means is for making the portable step unusable by other users by detaching at least a portion of the portable step from the object.

Another aspect of the invention includes an object securing means having a strap and a buckle.

Another aspect of the invention includes a locking means having a locking system and an opening in a strap.

Another aspect of the invention includes an incapacitating means having a removable step portion.

Another aspect of the invention includes an object securing means having a strap and a buckle, a locking means having a locking system and an opening in a strap, and an incapacitating means having a removable step portion.

### BRIEF DESCRIPTION OF THE DRAWINGS

FIG. 1 is a three dimensional drawing of a portable step in a non-climbing position.

FIG. 2 is a three dimensional drawing of portion of a portable step in a climbing position.

FIG. 3 is a three dimensional drawing of a buckle without an attached strap.

FIG. 4 is a three dimensional drawing of a step portion of a step assembly of a portable step.

FIG. 5 is three dimensional drawing of a base portion of a step assembly of a portable step.

FIG. 6 is three dimensional drawing of a portion of a portable step showing a locking system and lock.

### DESCRIPTION OF PREFERRED EMBODIMENT

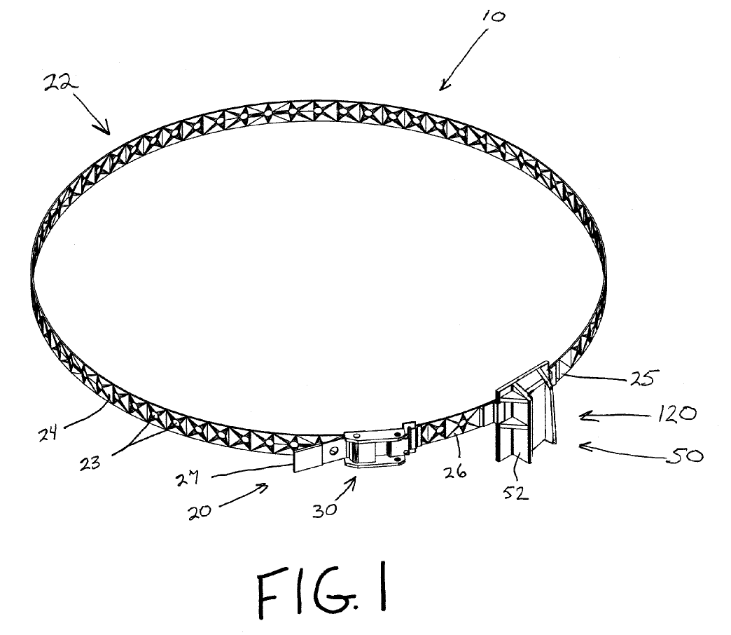

Generally, one embodiment of the device consists of a portable step 10 as shown in FIGS. 1 through 6.

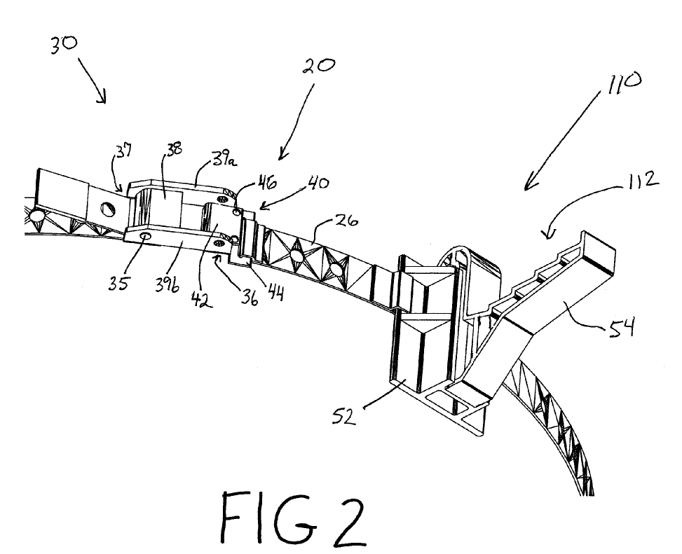

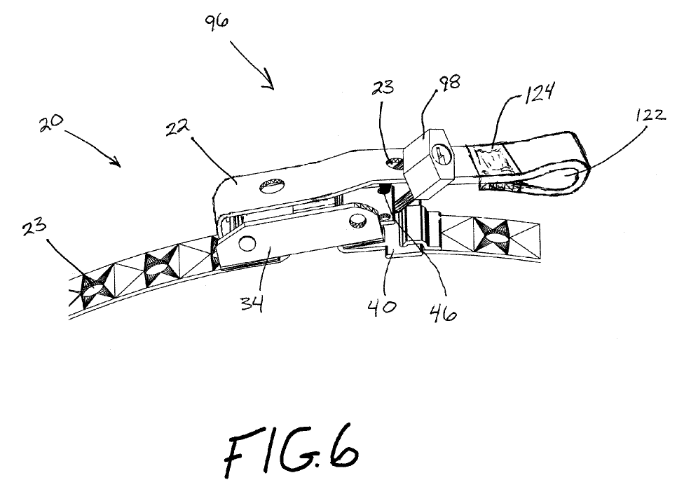

Referring to FIG. 1, one embodiment of the portable step 10 includes a strap assembly 20 attached to a base portion 52 of a step assembly 50. The portable step is designed to attach to an object to be climbed, such as a tree. Step assembly 50 is shown in a non-climbing position 120 without step portion 54 of step assembly 50. (See FIG. 2 for climbing position 110 including step portion 54 of step assembly 50) (The portable step may also include a locking system 96 and a lock 98 as shown in FIG. 6.)

Strap assembly 20 includes a strap 22 and a buckle 30. Strap 22 is preferably a nylon strap, however, other materials known in the art, such as natural fibers, or other synthetic fibers could also capably provide at least some of the characteristics of proper strength, elasticity, and wear resistance, depending on width and thickness. Strap 22 is preferably perforated with a plurality of openings or strap holes 23 along the length of at least a portion of strap 22. Strap holes 23 provide attachment points for a locking system 96 and lock 98 (See FIG. 6) so that the portable step 10 may be secured to an object. Strap 22 also may include an enlarged end 1 24, such as a double or triple thickness of strap 22 sewn together. Enlarged end 1 24 is thick enough so that it will not pass through the buckle 30. Enlarged end 1 24 ensures that strap assembly 20 remains together and available for use as well as enhances the security features of the portable step 10. Alternatively, strap 22 may include a strap holes comprised as one or more loops 122, either in addition to or as an alternative strap hole 23. (See FIG. 6). Strap 22 preferably consists of a long portion 24 and a short portion 26. A first end 25 of long portion 24 is attached to base portion 52 of step assembly 50. A second end 27 of long portion 24 is attached to buckle 30 by attaching the second end 27 to buckle 30. Preferably, buckle 30 is attached to step assembly 50 by short portion 26 of strap 22. Short portion 26 may be permanently sewn to hook 40 of buckle 30 at one end and the step assembly 50 on the opposite end. Alternatively, buckle 30 may be directly attached to base portion 52 of step assembly 50, eliminating the need for short portion 26 of strap 22.

Step assembly 50 includes a base portion 52 and a step portion 54. (See FIG. 2) Base portion 52 of step assembly 50 is preferably permanently attached to strap 22, but alternatively, may be removably attached to strap 22 or strap assembly 20. Step portion 54 (See FIG. 2) is removably attached to base portion 52 of step assembly 50.

Referring to FIG. 2, strap assembly 20 is attached to step assembly 50. Buckle 30 includes a buckle base 34 and hook 40. Buckle base 34 includes a cam 38 that is pivotally attached to buckle base 34 by pin 35. Buckle base 34 includes a latch 36 at one end of buckle base 34 and a cam plate 37 at the other end of the buckle base 34. Cam plate 37 and latch 36 are connected by arms 39a and 39b. Pin 35 is attached to arms 39. Cam 38 rotates about pin 35 so that cam 38 pinches long portion 24 of strap 22 against cam plate 37 when rotated in one direction and releases strap 22 when rotated in the opposite direction. Cam 38 and cam plate 37 of buckle 30 releasably attaches strap 22 to buckle 30.

Hook 40 includes a C-portion 42 at one end and a strap connector 44 at the other end. Hook 40 removably attaches to buckle base 34 by C-portion 42 of hook 40 partially circumscribing about latch 36 of buckle base 34. Hook 40 includes lock opening 46, preferably located in C-portion 42 of hook 40.

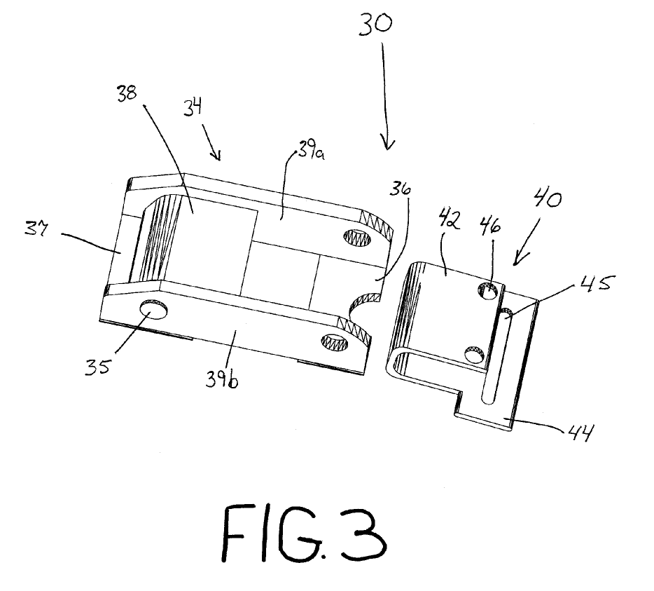

Referring to FIG. 3, buckle 30 is shown with out strap 22. Buckle 30 includes buckle base 34 and hook 40. Buckle base 34 includes a cam 38 that is pivotally attached to buckle base 34 by pin 35. Buckle base 34 includes a latch 36 at one end of buckle base 34 and a cam plate 37 at the other end of the buckle base 34. Cam plate 37 and latch 36 are connected by arms 39a and 39b. Pin 35 is attached to arms 39.

Hook 40 includes a C-portion 42 at one end and a strap connector 44 at the other end. Hook 40 removably attaches to buckle base 34 by C-portion 42 of hook 40 partially circumscribing about latch 36 of buckle base 34. Hook 40 includes lock opening 46, preferably located in C-portion 42 of hook 40. Strap connector 44 attaches one end of short portion 26 of strap 22 to hook 46 of buckle 30 by looping strap 22 through slotted opening 45 and permanently sewing or attaching the strap 22 back onto the strap 22.

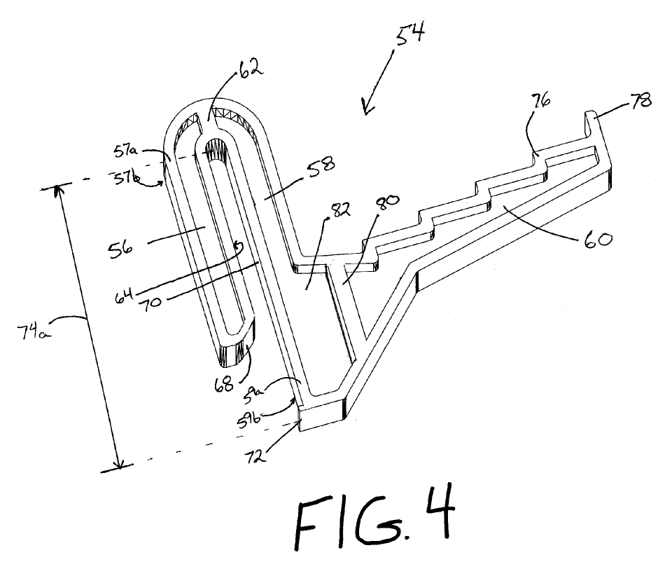

Referring to FIG. 4, step portion 54 of step assembly 50 is shown. Step portion 54 may be comprised of metal or plastic or other suitable materials. Step portion 54 includes an inner stem 56, an outer stem 58, and a step 60. Inner stem 56 and outer stem 58 are attached by cross member 62. Outer stem 58 is connected to step 60. Preferably, inner stem 56, outer stem 58, cross member 62, and step 60 are integral. Alternatively each piece could be separately molded or formed and attached to each other using fasteners, adhesives or the like. Inner stem 56 has an inner surface 64, an outer surface 66 and a beveled end 68. Outer stem 58 has an inner surface 70 having a vertical reach 74a from the cross member 62 to a locking stop 72. Step 60 includes cleats 76 and a step end stop 78 to provide more secure footing. Additionally, step 60 may include gussets 80 and cutouts 82 to improve strength and reduce weight of the device.

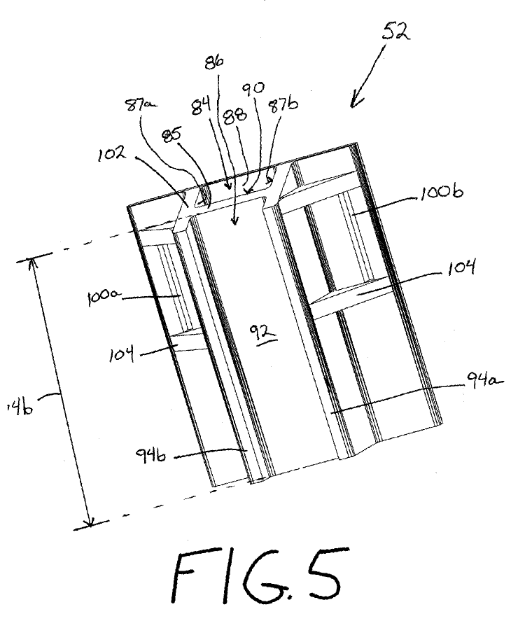

Referring to FIG. 5, base portion 52 of step assembly 50 is shown. Base portion 52 may be comprised of metal or plastic or other suitable materials. Base portion 52 receives and supports step portion 54. Base portion 52 includes an inner stem channel 84 and outer stem channel 86, both running vertically from substantially the top to the bottom of the base portion 52. Inner stem channel 84 and outer stem channel 86 are separated by a support 85. Inner stem channel 84 has an inner surface 88 and an outer surface 90. Outer stem channel 86 has a facing surface 92 with a vertical reach 74b and locking edges 94a and 94b. Inner stem 56 of step portion 54 is received by inner stem channel 84 with outer surface 66 of inner stem 56 mating with inner surface 88 of inner stem channel 84 and inner surface 64 of inner stem 56 mating with outer surface 90 of inner stem channel 84. At least a portion of the sides 87a and 87b of inner stem channel 84 snuggly fit against at least a portion of the sides of inner stem 58 to provide a more secure fit.

Outer stem 58 is received by outer stem channel 86 with inner surface 70 of outer stem 58 mating with facing surface 92 of outer stem channel 86 and cross member 62 of step portion 54 mating with support 85 of base portion 52 with inner surface 70 of outer stem 58 having a vertical reach 74a from the cross member 62 to locking stop 72 mating with vertical reach 74b of outer stem channel 86. Locking edges 94a and 94b of outer stem channel 86 snuggly fit against the sides 59a and 59b of outer stem 58. Alternatively, locking edges 94 may wrap or snap around gussets 80 and into cut outs 82 to provide a more secure fit. When inner stem 56 is inserted into inner stem channel 84 it easily inserts into base portion 54 due to beveled edge 68 of inner stem 56. When fully inserted, into inner stem channel 84, locking lip 72 of outer stem 58 snaps into a locked position, locking step portion 54 into the base portion 52. Locking step portion 54 into a locked position ensures that step portion 54 will not accidentally release from base portion 52. The locking edges and snug fitting sides also reduce side to side movement resulting in a more stable step for the climber.

Base 52 also includes strap openings 100a and 100b, a beveled top 102, and strength supports 104. Beveled top 102 of base portion 52 is beveled or sloped so that others will not be able to use base portion 52 as a step without step portion 54.

Referring to FIG. 6, Buckle 30 may include a locking system 96 that allows strap assembly 20 to be secured to an object to be climbed, such as a tree. Locking system 96 includes a plurality of holes 23 in strap 22 and lock opening 46 in hook 40. Alternatively, locking system 96 may include base opening 99 in buckle base 34. A lock 98 may be looped through strap opening 23 and either or both of hook opening 46 and base opening 99. Strap 22 also may include an enlarged end 1 24, such as a double or triple thickness of strap 22 sewn together. Enlarged end 1 24 is thick enough so that it will not pass through the buckle 30. Enlarged end 1 24 ensures that strap assembly 20 remains together and available for use as well as enhances the locking system of portable step 10. Alternatively, strap 22 may include strap hole 23 comprised as one or more loops 122, either in addition to or as an alternative strap hole 23. Alternatively, lock 98 may be looped through loop 22 and either or both of hook opening 46 and base opening 99.

To set up portable step 10, first wrap long portion 24 of strap 22 around the object to be climbed, such as a tree, hook the hook 40 of buckle 30 to buckle base 34 of buckle 30 by placing C-portion 42 substantially around latch 36. Next loop loose end 27 of long portion 24 of strap 22 under cam plate 37 and then between cam plate 37 and latch 36. Next loop strap 22 between cam plate 37 and cam 38, around cam 38 and back towards latch 36 and hook 40. If desired, lock strap 22 to buckle 30 using the closest strap opening 23. Loop lock 98 through strap opening 23 and through either or both of hook opening 46 and base opening 99.

Referring to FIGS. 1 through 6, the present embodiment provides a quick and secure ascent and descent from an object to be climbed, such as a tree. The embodiment includes a strap assembly 20, and a step assembly 50. The step assembly 50 includes a base portion 52 and a step portion 54. Strap assembly 20 and base portion 52 may be secured and left on a tree without damage to the tree and without someone else either using or taking the portable step 10. Step portion 54 of step assembly 50 is taken with the climber when not in use, leaving base portion 52 securely fastened to the tree. When the climber wants to use portable step 10, the climber reattaches step portion 54 to base portion 52 of step assembly 50. Step portion 54 has an outer stem 56 that slides into inner stem channel 84 on base portion 52 and snaps securely into place to ensure that it doesn't inadvertently slip out of base portion 52. Locking strap assembly 20 in place reduces the chance that portable step 10 will be stolen or removed. If it is removed, the device is likely to be damaged, such as cutting of strap 22 or breaking or bending of the base portion 52 or buckle 30, rendering it useless.

Sportsmen may set a series of portable steps early in the hunting season and return to use the same portable steps without having to transport heavy equipment and set up each time. They can easily lock the portable steps in place the first time they set it up and simply remove step portions 54 as they descend from a tree stand, for example. The next time they want to use the portable steps, they can simply reinsert the lightweight step portions 54 into each step as they ascend the tree.

The step assembly has a climbing position 110, as shown in FIG. 2, and a non-climbing position 1 20 as shown in FIG. 1. Climbing position 110 includes attached step portion 54 and non-climbing position 1 20 does not include step portion 54 or step portion 54 is detached from step assembly 50. Climbing position 110 provides a step 112.

Referring to FIGS. 1 through 6, a portable step 10 includes an object securing means, such as strap assembly 20 for attaching portable step 10 to an object, such as a tree, so that the object can be climbed. Object securing means may also include ropes, nails screws, fasteners, adhesive, or any other means to secure a base portion to an object to be climbed. The portable step includes a locking means, such as locking system 96, for securing at least a portion of the portable step to the object to prevent other users from removing the portable step from the object. Locking means may also include locks integral with buckle 30, padlocks, combination locks, fasteners, ratchets, alarms, or systems designed to facilitate such locking means. Incapacitating means, such as removing step portion 54, for making the portable step unusable by other users by detaching at least a portion of the portable step from the object. Incapacitating means may include beveled tops or repositioning of a portion of the device into a non-use position.

While there is shown and described the present preferred embodiment of the invention, it is understood that this invention is not limited thereto but may be variously embodied to practice within the scope of the following claims. From the foregoing description, it will be apparent that various changes may be made without departing from the spirit and scope of the invention as defined by the following claims. It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A portable step comprising:
a strap assembly, said strap assembly removably attachable to a climbable object, the object having a circumference, said strap assembly having a length of at least the circumference of the climbable object, said strap assembly attachable to the object by circumscribing the object;
a step assembly having a base portion and a step portion, said base portion attached to said strap assembly, said step portion removably attachable to said base portion, said step assembly having a climbing position and a non-climbing position, said climbing position comprising an attached step portion and said non-climbing position comprising a detached step portion; said step assembly in said climbing position providing a step.

2. The portable step of claim 1 wherein said base portion further comprises a beveled top.

3. The portable step of claim 1 wherein said base portion further comprises a stem for inserting into a channel, said stem and said channel having at least two mating surfaces.

4. The portable step of claim 3 wherein said step assembly further comprises at least one locking lip and at least one locking edge.

5. The portable step of claim 1 wherein said strap assembly further comprises a buckle having a buckle base and a hook, said buckle base having a cam, said cam securing one end of a strap of said strap assembly.

6. The portable step of claim 5 further comprising a locking system.

7. The portable step of claim 6 wherein the locking system comprises a plurality of holes in a strap of said strap assembly and an opening in a buckle of said strap assembly.

8. The portable step of claim 1 wherein said strap assembly comprises a strap and a buckle.

9. A portable step comprising:
a strap assembly, said strap assembly removably attachable to a climbable object, the object having a circumference, said strap assembly having a length of at least the circumference, said strap assembly attachable to the object by circumscribing the object;
a step assembly attached to said strap assembly, said step assembly having a climbing position and a non-climbing position, said step assembly in said climbing position providing a step;
a locking system, said locking system attached to said strap assembly, wherein said strap assembly is securable to the climbable object;
wherein said strap assembly is lockably securable to said object while said step assembly is in said climbing position;
wherein said strap assembly is lockably securable to said object while said step assembly is in said non-climbing position.

10. The portable step of claim 9 wherein said locking system further comprises a plurality of openings in a strap of said strap assembly and an opening in a hook of a buckle of said strap assembly.

11. The portable step of claim 9 wherein
said step assembly has a base portion and a step portion,
said base portion is attached to said strap assembly,
said step portion is removably attachable to said base portion,
said climbing position comprises an attached step portion and said non-climbing position comprises a detached step portion; and
said step portion of said step assembly in said climbing position provides a step.

12. The portable step of claim 11 wherein said base portion further comprises a beveled top.

13. The portable step of claim 11 wherein said base portion further comprises a stem for inserting into a channel, said stem and said channel having at least two mating surfaces.

14. The portable step of claim 13 wherein said step assembly further comprises at least one locking lip and at least one locking edge.

15. The portable step of claim 9 wherein said strap assembly further comprises a buckle having a buckle base and a hook, said buckle base having a cam, said cam securing one end of a strap of said strap assembly.

16. A portable step comprising:
an object securing means for attaching the portable step to an object so that the object can be climbed,
a locking means for securing at least a portion of the portable step to the object to prevent other users from removing the portable step from the object;
an incapacitating means for making the portable step unusable by other users by detaching at least a portion of the portable step from the object.

17. The device of claim 16 wherein the object securing means comprises a strap and a buckle.

18. The device of claim 16 wherein the locking means comprises a locking system and an opening in a strap.

19. The device of claim 16 wherein the incapacitating means comprises a removable step portion.

20. The device of claim 16 wherein the object securing means comprises a strap and a buckle, the locking means comprises a locking system and an opening in a strap, and the incapacitating means comprises a removable step portion.
